(19) United States
(12) Patent Application Publication
(10) Pub. No.: US 2012/0300378 A1
(43) Pub. Date: Nov. 29, 2012

(54) DOCKING STATION FOR TABLET COMPUTER

(75) Inventors: TUNG-CHUN TSAI, Tu-Cheng (TW); SHIH-WEN CHIANG, Tu-Cheng (TW); YEN-CHI TSAI, Tu-Cheng (TW); WEI-YU WANG, Tu-Cheng (TW)

(73) Assignee: HON HAI PRECISION INDUSTRY CO., LTD., Tu-Cheng (TW)

(21) Appl. No.: 13/304,347

(22) Filed: Nov. 24, 2011

(30) Foreign Application Priority Data
May 27, 2011 (TW) 100118766

(51) Int. Cl. G06F 1/16

(52) U.S. Cl. 361/679.3; 361/679.41

(57) ABSTRACT

A docking station for receiving a tablet computer is disclosed. The docking station for a tablet computer comprises a bracket defining a restricting space, a flange mounted on the bracket, the flange defining a cutout above the restricting space; and a sliding member movably mounted on the flange, wherein the sliding member is adapted to move on the flange between a first position and a second position; in the first position, the sliding member is moved into the cutout, the restricting space is separated from an outer space of the docking station; and in the second position, the sliding member is moved out of the cutout, the restricting space is communicating with the outer space of the docking station via the cutout.

### BACKGROUND

1. Technical Field

The present disclosure relates to a docking station, and more particularly to a docking station for receiving a tablet computer.

2. Description of Related Art

A tablet computer is a mobile computer and often integrated into a flat, tablet screen, and may be primarily operated by touching the tablet screen. In a tablet computer, the processor may be part of the tablet screen. The tablet computer usually provides a user interface with the processor through the tablet screen. The user may enter text directly on the tablet screen using a digital pen, plastic pen, or fingers. Usually, the tablet computer is small and compact, and portable. However, the tablet screen of the tablet computer may be too small for certain conditions, such as conferencing.

Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded and isometric view of an embodiment of a docking station and a tablet computer.

FIG. 2 is an enlarged view of an encircled portion II of FIG. 1.

FIG. 3 is an isometric view of a sliding member of the docking station of FIG. 1.

FIG. 4 is an unfinished assembly view of the docking station and the tablet computer of FIG. 1.

FIG. 5 is a finished assembly view of the docking station and the tablet computer of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

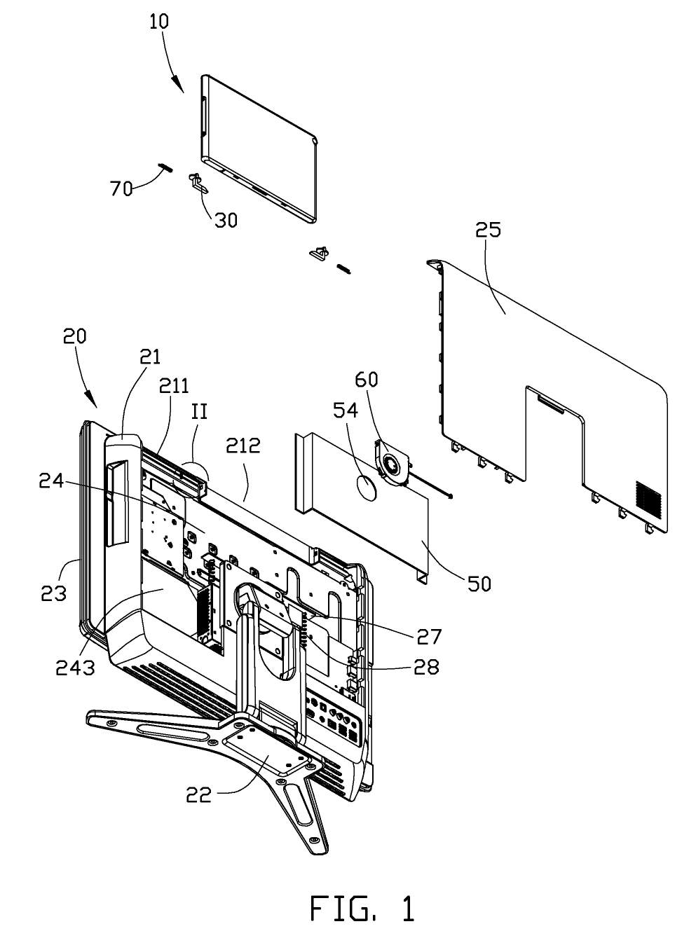

Referring to FIG. 1, a docking station 20 for a tablet computer 10 in accordance with an embodiment comprises a bracket 21 and a base 22. The base 22 is pivotally mounted on the bracket 21 for support.

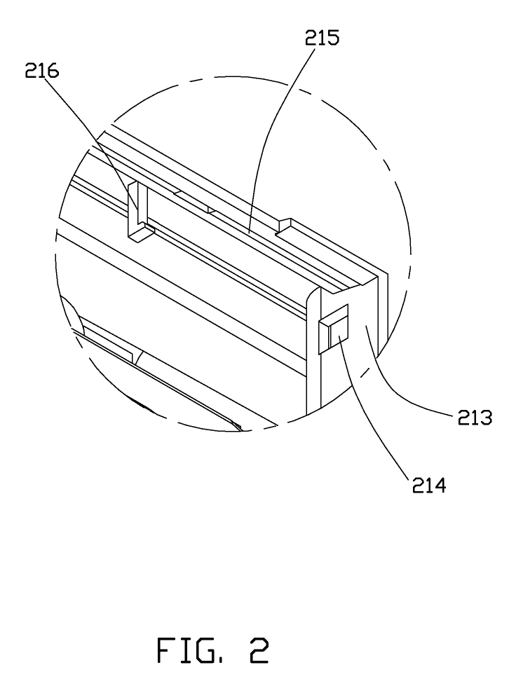

Referring to FIGS. 1 and 2, a screen 23 is equipped on a front side of the bracket 21. A rear side of the bracket 21 defines a receiving room 24. A plurality of electronic components 243 are mounted in the receiving room 24. The plurality of electronic components 243 comprise hard disk drives, optical disk drives, power supply units, and a plurality of connectors. A flange 211 is located above the receiving room 24 and aligned with the receiving room 24. A middle portion of the flange 211 defines a cutout 212. A width of the cutout 212 is slightly larger than that of the tablet computer 10. The flange 211 forms a pair of bent pieces 213 bounding the cutout 212. Each of the pair of bent pieces 213 defines a through hole 214. The flange 211 defines a sliding groove 215 adjacent to each of the pair of bent pieces 213. A pair of clasps 216 are located on the flange 211. Each of the pair of clasps 216 is next to one sliding groove 215. A supporting piece 27 is located in the receiving room 24. The supporting piece 27 is aligned with the cutout 212 and is located below the cutout 212. A side of the supporting piece 27 is connected to a pair of supporting springs 28. The pair of supporting springs 28 are further connected to the bracket 21, supporting the supporting piece 27. The supporting piece 27 may slide up or down in the receiving room 24 to extend or compress the pair of supporting springs 28.

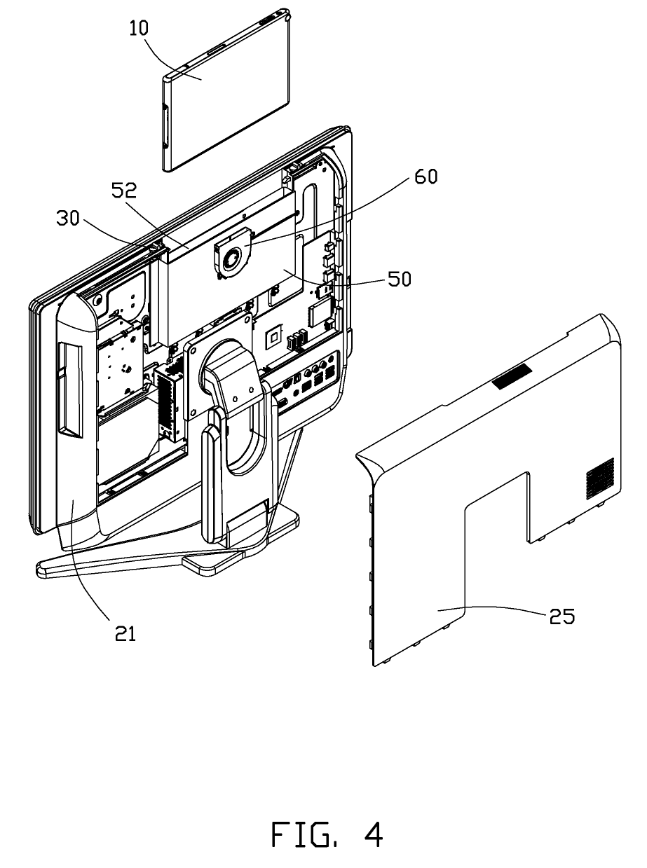

A restricting piece 50 may be mounted in the receiving room 24 to form a restricting space 52 (referring to FIG. 4) in the receiving room 24. A width of the restricting space 52 is generally equal to that of the tablet computer 10. The restricting piece 50 defines an air vent hole 54. A fan 60 may be mounted in the air vent hole 54.

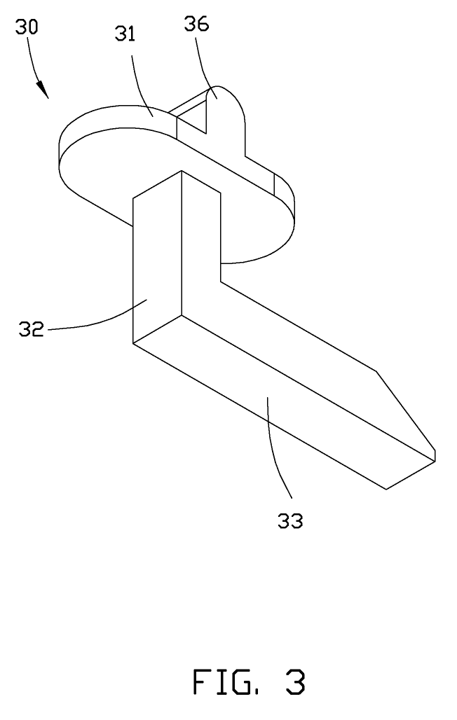

Referring to FIGS. 1 and 3, a sliding member 30 may slide in the sliding groove 215 of the flange 211. The sliding member 30 comprises a cap 31, and a sliding portion 32 extending from a bottom side of the cap 31. A handle 36 is formed on a top side of the cap 31. A distal end of the sliding portion 32 extends perpendicularly to form an inserting portion 33. A width of the sliding groove 215 is smaller than a width of the cap 31 and larger than a width of the sliding portion 32 and a width of the inserting portion 33.

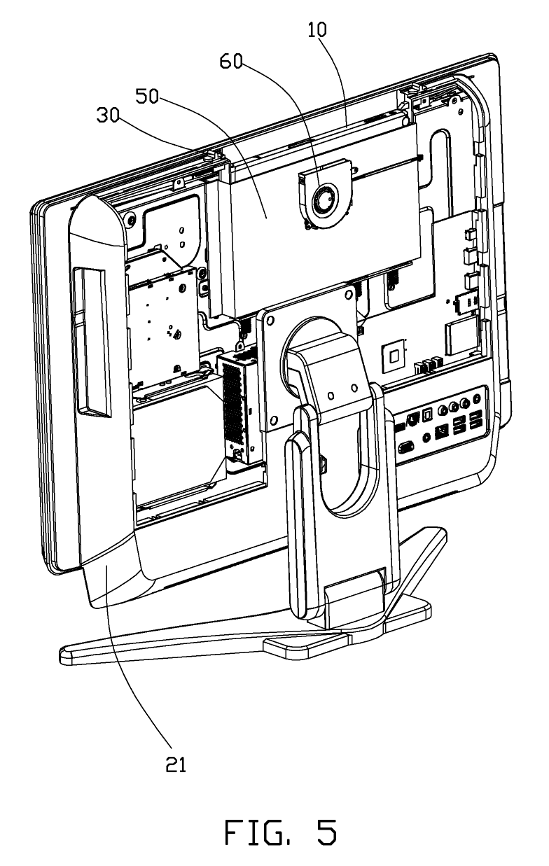

Referring to FIGS. 1 to 5, in assembly, the sliding portion 32 of the sliding member 30 is inserted and received in the sliding groove 215. The cap 31 is located on the flange 211. The sliding portion 32 slides in the sliding groove 215 so that the inserting portion 33 may be inserted into the through hole 214. One end of a reset spring 70 is mounted on the sliding member 30, and one other end of the reset spring 70 is mounted on the clasp 216. When the reset spring 70 is uncompressed, the inserting portion 33 is in the through hole 214 and positioned in the cutout 212.

Then the restricting piece 50 is mounted in the receiving room 24 to form the restricting space 52. The fan 60 is mounted in the air vent hole 54. In this position, the restricting space 52 is aligned with the cutout 212 and is below the cutout 212. The supporting piece 27 is received in the restricting space 52. Finally, a cover 25 is mounted on the bracket 21 to shield the receiving room 24. The docking station 20 is assembled.

When the tablet computer 10 needs to be put in the docking station 20, the sliding member 30 slides first in the sliding groove 215 to move the inserting portion 33 out of the cutout 212 and out of the through hole 214. The reset spring 70 is elastically compressed. The tablet computer 10 is moved into the restricting space 52 through the cutout 212. The tablet computer 10 is positioned on the supporting piece 27. The pair of supporting springs 28 are compressed. The tablet computer 10 is moved further to completed pass through the cutout 212. Then the sliding member 30 is released, the reset spring 70 rebounds to insert the inserting portion 33 into the through hole 214 and into the cutout 212. The inserting portion 33 resists a top side of the tablet computer 10 to block the tablet computer 10 from moving out of the restricting space 52. At this position, the tablet computer 10 may be electrically connected to the docking station 20 via connectors. The docking station 20 may receive data from the tablet computer 10, and the screen 23 may show data from the tablet computer 10.

When the tablet computer 10 needs to be moved out of the docking station 20, the sliding member 30 first slides in the sliding groove 215 to move the inserting portion 33 out of the cutout 212 so that the sliding member 30 does not block the tablet computer 10. The pair of supporting springs 28 rebound to move the supporting piece 27 and the tablet computer 10 upward to the cutout 212. Then the tablet computer 10 may be moved out of the restricting space 52.

It is to be understood, however, that even though numerous characteristics and advantages of the embodiments have been set forth in the foregoing description, together with details of the structure and functions of the embodiments, the disclosure is illustrative only, and changes may be made in detail, especially in the matters of shape, size, and arrangement of parts within the principles of the invention to the full extent indicated by the broad general meaning of the terms in which the appended claims are expressed.

What is claimed is:

1. A docking station for a tablet computer, comprising:
a bracket defining a restricting space, a flange mounted on the bracket, the flange defining a cutout above the restricting space; and
a sliding member movably mounted on the flange, wherein the sliding member is adapted to move on the flange between a first position and a second position; in the first position, the sliding member is moved into the cutout, the restricting space is separated from an outer space of the docking station; and in the second position, the sliding member is moved out of the cutout, the restricting space is communicating with the outer space of the docking station via the cutout.

2. The docking station of claim 1, wherein the flanges comprises a bent piece which bounds the cutout, the bent piece defines a through hole aligned with the cutout; the sliding member comprises an inserting portion, the inserting portion is inserted into the through hole in the first position, and the inserting portion is moved out of the through hole in the second position.

3. The docking station of claim 2, the sliding member comprises a sliding portion which is perpendicularly connected to the inserting portion, the flange of the bracket defines a sliding groove, wherein the sliding portion is adapted to slide in the sliding groove between the first position and the second position.

4. The docking station of claim 3, the sliding portion comprises a cap and a handle, wherein the sliding portion is connected to a bottom side of the cap, the handle is connected to a top side of the cap, a width of the sliding groove is smaller a width of the cap and larger than a width of the sliding portion, and the cap is on the flange when the sliding portion is in the sliding groove.

5. The docking station of claim 1, wherein a clasp is on the flange, a first end of a reset spring is mounted on the clasp, and a second end of the reset spring is mounted on the sliding member; the reset spring is not compressed in the first position, and the reset spring is compressed in the second position.

6. The docking station of claim 1, wherein the restricting space is formed by a restricting piece mounted in the bracket, the restricting piece defines an air vent hole, and a fan is mounted in the air vent hole.

7. The docking station of claim 6, wherein a supporting piece is slidably mounted in the restricting piece, and the supporting piece is adapted to support a tablet computer thereon.

8. The docking station of claim 7, wherein the supporting piece is connected to the bracket via a supporting spring, and the supporting spring is compressed when the supporting piece supports the tablet computer thereon.

9. The docking station of claim 1, wherein a plurality of electronic components are mounted in the bracket, and the plurality of electronic components are adapted to connect to the tablet computer.

10. The docking station of claim 9, wherein the plurality of electronic components comprises a screen adapted to display information from the tablet computer.

11. An assembly, comprising:
a tablet computer;
a bracket defining a restricting space, a flange mounted on the bracket, a supporting piece slidably mounted in the restricting space; wherein the supporting piece is connected to the bracket via a supporting spring; when the tablet computer is in the restricting space, the tablet computer rests on the supporting piece and is resisted by the supporting spring; and
a sliding member movably mounted on the flange, wherein the sliding member is adapted to move on the flange between a first position and a second position; in the first position, the sliding member abuts the tablet computer and blocks the tablet computer from moving out of the restricting space; and in the second position, the sliding member is moved away from the tablet computer and the tablet computer is not blocked by the sliding member.

12. The assembly of claim 11, wherein the flange defines a cutout above the restricting space; the sliding member is in the cutout in the first position, and the sliding member is out of the cutout in the second position.

13. The assembly of claim 12, wherein the flanges comprises a bent piece which bounds the cutout, the bent piece defines a through hole aligned with the cutout; the sliding member comprises an inserting portion, the inserting portion is inserted into the through hole in the first position, and the inserting portion is moved out of the through hole in the second position.

14. The assembly of claim 13, the sliding member comprises a sliding portion which is perpendicularly connected to the inserting portion, the flange of the bracket defines a sliding groove, wherein the sliding portion is adapted to slide in the sliding groove between the first position and the second position.

15. The assembly of claim 14, the sliding portion comprises a cap and a handle, wherein the sliding portion is connected to a bottom side of the cap, the handle is connected to a top side of the cap, a width of the sliding groove is smaller than a width of the cap and larger than a width of the sliding portion, and the cap is on the flange when the sliding portion is in the sliding groove.

16. The assembly of claim 11, wherein a clasp is located on the flange, a first end of a reset spring is mounted on the clasp, and a second end of the reset spring is mounted on the sliding member; the reset spring is not compressed in the first position, and the reset spring is compressed in the second position.

17. The assembly of claim 11, wherein the restricting space is formed by a restricting piece mounted in the bracket, the restricting piece defines an air vent hole, and a fan is mounted in the air vent hole.

18. The assembly of claim 11, wherein a plurality of electronic components are mounted in the bracket, and the tablet computer is connected to the plurality of electronic components.

19. The assembly of claim 18, wherein the plurality of electronic components comprise a screen adapted to display information from the tablet computer.
